(19) United States
(12) Patent Application Publication
(10) Pub. No.: US 2007/0087319 A1
(43) Pub. Date: Apr. 19, 2007

(54) REMOTE TRAINING OF STUDENTS

(75) Inventors: Peter M. Roberts, Eagle, ID (US); David M. Roberts, Pickens, SC (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: PETER ROBERTS PRODUCTIONS INC., Eagle, ID (US)

(21) Appl. No.: 11/539,961

(22) Filed: Oct. 10, 2006

Related U.S. Application Data
(60) Provisional application No. 60/725,355, filed on Oct. 11, 2005.

(51) Int. Cl. G09B 3/00

(52) U.S. Cl. 434/350

(57) ABSTRACT

A method of remote training by a trainer of an activity, such as horseback riding, performed by a student. The method includes receiving and reviewing real time video of student actions over a network, the student being located at a location, and based upon the real time video, providing instructions to the student. A method is also provided for receiving remote training from a trainer. A computerized method is provided for remote training by a trainer of an activity performed by a student. The method includes maintaining information about availability of a trainer, and providing a first user interface through which a student may select a trainer. A second user interface may be provided for selecting an arena.

### REFERENCE TO RELATED APPLICATIONS

This application claims priority to U.S. provisional patent application Ser. No. 60/725,355, filed Oct. 11, 2005, and incorporated herein by reference.

### TECHNICAL FIELD OF THE INVENTION

The present invention relates to computer implemented business methods, and more specifically to remote training of a student via a computer network.

### BACKGROUND OF THE INVENTION

People have real-time experiences over great distances in a variety of ways. Video conferencing allows people to see and talk to people in remote offices. People talk on the phone. Doctors in New York State evaluate children in daycare centers using Internet web cams.

Some distance learning systems deliver a student's image to a teacher in real-time so the teacher can offer immediate feedback on the student's performance. In one such system a music teacher offers real-time guitar lessons to a student playing a guitar in front of a web cam.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a method is provided of remote training by a trainer of an activity performed by a student. The method includes receiving and reviewing real time video of student actions over a network, the student being located at a location, and based upon the real time video, providing instructions to the student.

In accordance with another embodiment, a method is provided for receiving remote training from a trainer. The method includes transmitting real time video of student actions over a network, the student being located at a location, and receiving instructions based upon the real time video to the student.

In accordance with still another embodiment, a computerized method is provided for remote training by a trainer of an activity performed by a student. The method includes maintaining information about availability of a trainer, and providing a first user interface through which a student may select a trainer.

Other features of the invention will become apparent from the following detailed description when taken in conjunction with the drawings, in which:

### BRIEF DESCRIPTION OF THE DRAWINGS

FIG. 1 is a block diagram representing a computer network into which the present invention may be incorporated;

FIG. 2 is a block diagram of an architecture of a computer through which the present invention may be implemented;

FIG. 3 is a block diagram representing a remote training system in accordance with an embodiment;

FIG. 4 is a representation of a screen shot of a search page in accordance with an embodiment;

FIG. 5 is a representation of a calendar page in accordance with an embodiment;

FIG. 6 is a side perspective view of a representation of an arena in accordance with an embodiment;

FIG. 7 is a block diagram representing an arena computer in accordance with an embodiment;

FIG. 8 is a representation of a video analyzer page in accordance with an embodiment;

FIG. 9 is a block diagram representing a trainer computer in accordance with an embodiment;

FIG. 10 is a block diagram representing a training server in accordance with an embodiment;

FIG. 11 is a diagrammatic representation of a camera connected to a wireless headset in accordance with an embodiment;

FIG. 12 is a detailed view showing connectors for the headset of FIG. 11; and

FIG. 13 is a circuit that may be used with the headset of FIG. 11.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Prior to proceeding with a description of the various embodiments of the invention, a description of an example computer and an example networking environment in which the various embodiments of the invention may be practiced will now be provided. Although it is not required, the present invention may be implemented by programs that are executed by a computer. Generally, such programs include routines, objects, components, data structures and the like that perform particular tasks or implement particular abstract data types. The term “program” as used herein may connote a single program module or multiple program modules acting in concert. The term “computer” as used herein includes any device that electronically executes one or more programs, such as personal computers (PCs), hand-held devices, tablet PCs, multi-processor systems, microprocessor-based programmable consumer electronics, network PCs, minicomputers, mainframe computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

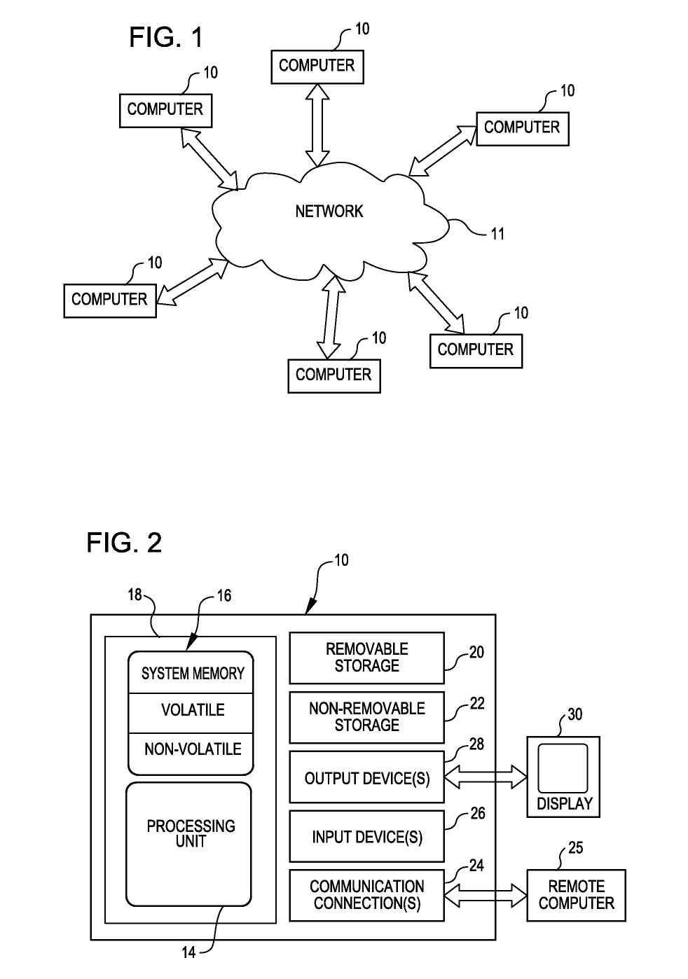

An example of a networked environment in which the invention may be used is described with reference to FIG. 1. The example network includes several computers 10 communicating with one another over a network 11, represented by a cloud. The network 11 may include many well-known components, such as routers, gateways, hubs, etc. and allows the computers 10 to communicate via wired and/or wireless methodologies. When interacting with one another over the network 11, one or more of the computers 10 may act as clients, servers or peers with respect to other computers 10. Accordingly, the various embodiments of the invention may be practiced on clients, servers, peers or combinations thereof, even though specific examples contained herein do not refer to all of these types of computers.

Referring to FIG. 2, an example of a basic configuration for a computer 10 on which all or parts of the invention described herein may be implemented is shown. In its most basic configuration, the computer 10 typically includes at least one processing unit 14 and memory 16. The processing unit 14 executes instructions to carry out tasks in accordance with various embodiments of the invention. In carrying out such tasks, the processing unit 14 may transmit electronic signals to other parts of the computer 10 and to devices outside of the computer 10 to cause some result. Depending on the exact configuration and type of the computer 10, the memory 16 may be volatile (such as RAM), non-volatile (such as ROM or flash memory) or some combination of the two. This most basic configuration is illustrated in FIG. 2 by dashed line 18.

The computer 10 may have additional features and/or functionality. For example, the computer 10 may also include additional storage (removable storage 20 and/or non-removable storage 22) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 10. Any such computer storage media may be part of computer 10.

The computer 10 preferably also includes communications connections 24 that allow the computer 10 to communicate with other devices, such as other computers on the network 11, or a remote computer 25. The remote computer 25 may be configured similar to the computer 10, or differently. A communication connection (e.g., one of the communication connections 24) is an example of a communication medium. Communication media typically embody computer readable instructions, data structures, program modules or other data in a modulated data signal such as a carrier wave or other transport mechanism and include any information delivery media. By way of example, and not limitation, the term “communication media” includes wired media such as a wired network or direct-wired connection, and wireless media such as acoustic, RF, infrared, and other wireless media. The term “computer-readable medium” as used herein includes both computer storage media and communication media.

The computer 10 may also have input devices 26 such as a keyboard, mouse, pen, voice input device, data disc drives, touch input device, a joystick, etc. Output devices 28 such as a display 30, speakers, a printer, etc. may also be included. All these devices are well known in the art and are not discussed at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer 10 of electrical signals representing data in a structured form. This manipulation transforms the data or maintains it at locations in the memory system of the computer 10, which reconfigures or otherwise alters the operation of the computer 10 in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

The present invention is generally directed to remote teaching. The invention has particular relevance to instruction of a student by a trainer, for example, in horseback riding.

In the horseback riding industry, in particular dressage and the jumper events, riders travel with their horses for miles to receive instruction from established trainers. The travel of the riders is expensive, and may involve trailering a horse several hundreds of miles. Trainers have to travel as well, as the established trainers are in demand throughout the world. Many trainers opt for early retirement instead of maintaining the grueling travel circuit.

In accordance with an embodiment, remote real time instruction is provided via a computer network, and may be provided, for example, through the Internet. This real time instruction permits a rider to travel to a local arena and receive real time instruction from a remote trainer.

Although described for use with reference to horse training, the invention may be used for multiple other teacher/student environments including, but not limited to, basketball, soccer, track and field, boxing, fencing, golf, weight training, yoga, and gymnastics.

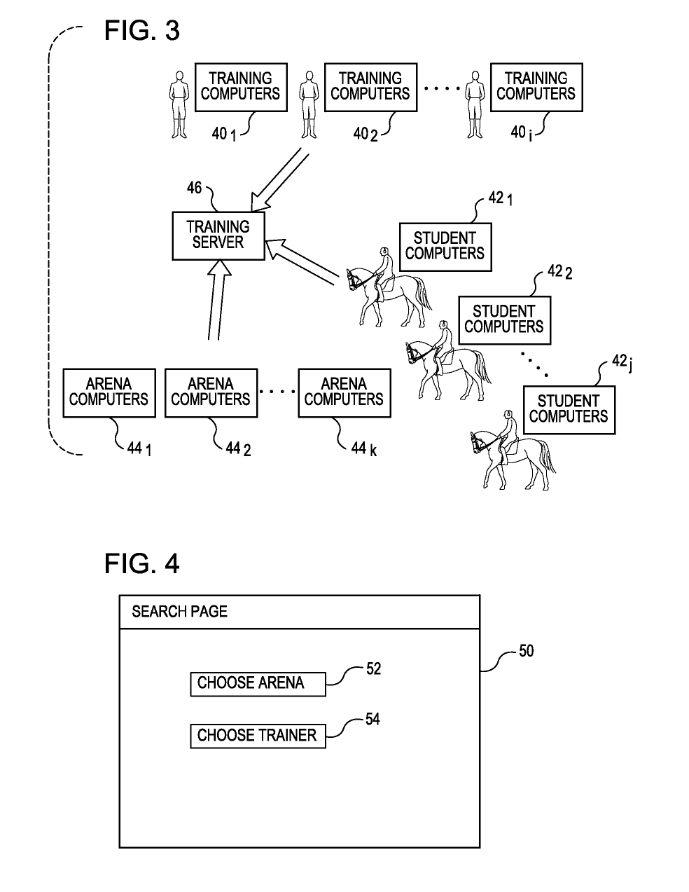

FIG. 3 is a block diagram representing a training system in accordance with an embodiment. The training system includes one or more training computers 40₁, 40₂ . . . 40ᵢ. One or more student computers 42₁, 42₂ . . . 42ⱼ are also connected to the system. Arena computers 44₁, 44₂ . . . 44k are also connected to the system. In the embodiment shown in the drawings, a training server 46 is provided that connects each of these systems. The training server 46 may be accessed through a network such as the network 11 described above. The network 11 in one embodiment is the Internet, but other networks may be used.

If desired, features of the training server 46 may be incorporated into one of the training computers 40, one of the arena computers 44, one of the student computers 42, or may be distributed over two or more of these computers. In addition, features of each of the computers may be alternatively provided on other computers and accessed through the network 11. To this end, the diagram in FIG. 3 is provided as a visual representation of the system, but components may be provided in an alternate arrangement to those described here.

In accordance with an embodiment, the training server 46 includes a transaction component 132 (FIG. 10). The transaction component 132 permits a student, for example via one of the student computers 42, to schedule a remote training session. To this end, the transaction component 132 may maintain information about public arenas that are available for training sessions for a student. The arenas may be, for example, a public riding barn, a riding stable, or other location where a student may ride a horse and be viewed for remote training. In accordance with an embodiment, each of the arenas that participate in the system includes at least one of the arena computers 44. In an embodiment, the transaction component 132 maintains information about availability of public arenas, as further described below.

In an embodiment, the transaction component 132 also permits a trainer to access the training server 46 to provide time slots that represent the trainer's availability. Information about availability of trainers may be maintained by the transaction component 132, and in an embodiment, may be updated by a trainer via a training computer 40 or any computer attached to the network.

The transaction component 132 permits an authorized student to schedule a public arena and/or available time of a trainer. In an embodiment, a student, for example via one of the student computers 42, logs into the training server 46 and is authenticated, for example, by an authorization components 134. As part of an authorization process, a user may be requested a user name and password, for example, if the user has used the system in the past. If not, then the user may establish an account with the system, for example, by entering address and personal information, including billing information. As an example, a credit card may be given.

In an embodiment, where the network 11 is the Internet, a student may log into the system via any computer 10 connected to the Internet.

After authenticated, a student may choose a convenient arena and/or trainer utilizing the information that is maintained by the transaction component 132. A user may own an arena or otherwise have access to one, and therefore may not need to schedule an arena, and thus may only need to schedule time with a trainer. In an alternate embodiment, information about available training times for students may be maintained via the transaction component 132, and a trainer may access this information via the transaction component 132 to schedule remote training of a particular student of students.

Assuming the student is the one selecting a trainer and an arena, the transaction component 132 may provide an authorized user a search page 50 shown in FIG. 4. The search page 50 includes a choose arena button 52 and a choose trainer button 54. Each of these buttons 52, 54 may navigate an authorized user to one or more additional pages. For example, for the choose arena button 52, the user may type in a zip code or some other geographical information and may be provided information about local public arenas. Further information may be provided about the arenas, such as available times for scheduling of the arenas and cost for rental. A user may select multiple different arenas that the user would like to use, or only a single arena, or may state that the user is willing to travel a particular number of miles to an arena and/or pay a particular price for use of an arena.

Similarly, the choose trainer button 54 may navigate a user to a separate page to choose a particular trainer. The trainer may be chosen by name, specialty, availability, or another category. Various search features may be provided. As an alternate to navigating to additional pages, the choose arena and choose trainer buttons 52, 54 may be drop down menus that allow selection of a particular trainer or type of trainer and a particular arena or location of arena. In any event, a potential student may select a potential arena and/or trainer via a user interface provided through the training server 46.

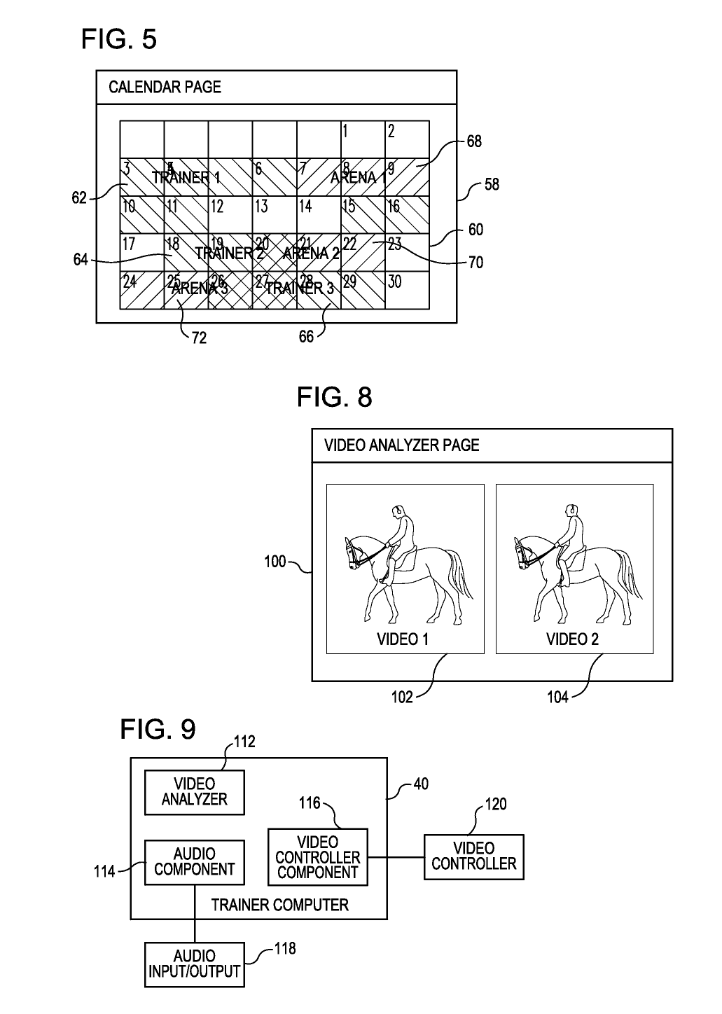

FIG. 5 shows a representation of a calendar page 58 that may show trainer and arena availability after a user has selected a particular number of trainers and arenas. In the embodiment shown in the drawings, trainer 1 is available for a time frame 62, trainer 2 is available for a time frame 64, and trainer 3 is available for a time frame 66. Arena 1 is available for a time frame 68, arena 2 is available for a time frame 70, and arena 3 is available for a time frame 72. The user may view the calendar 60 to see overlapping times of arena and trainer availability so as to schedule an appropriate time and date for remote training. For example, trainer 2 and arena 2 may be utilized on the 20^{th} of the month shown by the calendar page 58. Although the calendar page 58 is shown as one way of selecting an arena and trainer pair, other methods may be used.

After a training session has been scheduled, a confirmation is sent to the student and the trainer so that the training session may take place at the appropriate time. In addition, a message or other scheduling information may be provided to the arena that has been selected.

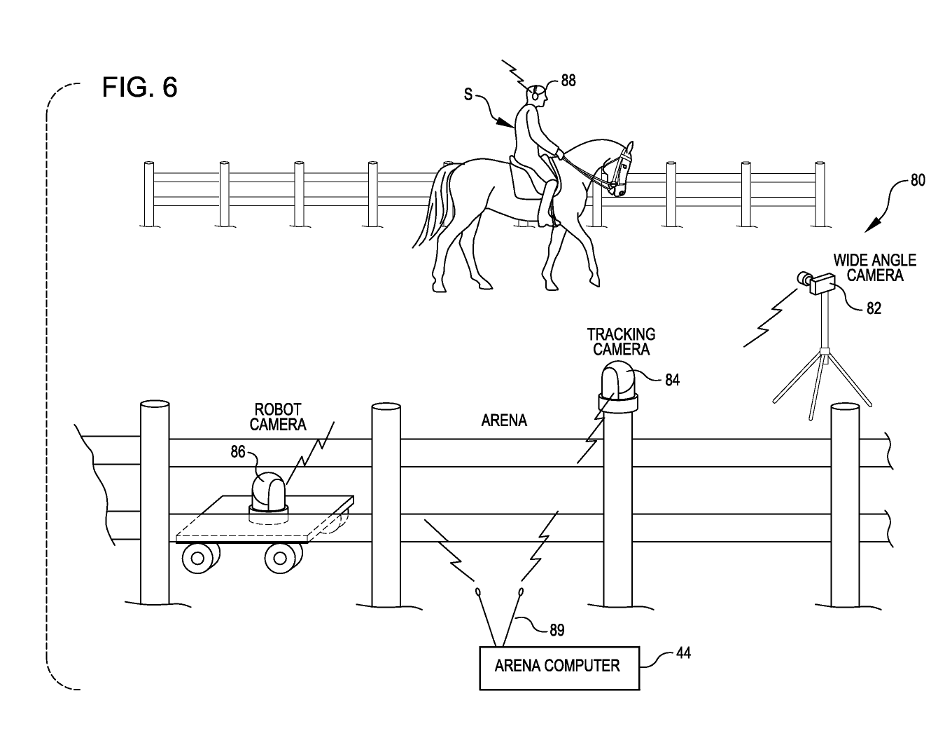

At the scheduled time, a student S (FIG. 6) goes to the scheduled arena 80 for a training session. As stated above, the session may take place at a private arena, wherein scheduling of an arena is not required. However, in an embodiment, the private arena may be utilized as described with respect to the arena 80.

The arena 80 shown in FIG. 6 includes a wide angle video camera 82 and a tracking video camera 84. In addition to the tracking camera 84 or instead of the tracking camera, a robot video camera 86 may be provided. An arena computer 44 is provided for the arena and may include, for example, an antenna 89. The wide angle video camera 82, the tracking video camera 84 and/or the robot video camera 86 are connected to provide a video signal to the arena computer 44. The signal may be provided via wired connection or via a wireless connection. If via a wireless connection, then the antenna 89 may be utilized for receiving the signal.

The arena computer 44 also receives audio signal during a training session. This audio signal may be provided, for example, via a headset 88 that is worn by the student S. This headset 88 may be designed to receive and transmit a wireless audio signal to and from the arena computer 44. The headset 88 may be, for example, a Plantronics CS50 900 MHz Wireless Office Headset System, but other headsets may be used. An audio signal may alternatively be provided via a cell phone or other telephone connection separate from the network 11, or may be provided to one of the cameras 82, 84, and/or 86, which in turn combines the audio and video information for processing and transmission by the arena computer 44. If the audio signal is provided to one of the cameras, preferably the camera utilizes full duplex audio that can be transmitted and received through a network connection, such as the Internet. Full duplex audio utilizes signals in both directions simultaneously, allowing simultaneous transmissions from both ends. A typical land phone system provides full duplex communications.

In an embodiment, the wide angle camera 82 is designed to broadly show the arena 80 so that a remote trainer does not risk guiding a student S and the student's horse into a fence, another user, or some other obstacle. The tracking camera 84 and/or the robot camera 86 are designed to follow the movements of the student S. The tracking camera 84 and/or the robot camera 86 may be, for example, a Sony SNC-RZ50N, which is a pan-tilt zoom Internet Protocol (IP) security camera. Such a security camera is designed for sending video over the Internet, and to be controlled from a remote site, for example through the Internet. The camera utilizes very high image quality and has full duplex audio for use with an external microphone that is directly connected to the camera. The robot camera 86 may be such a camera mounted on a robot platform, such as a R1 Mobile Robotic Platform from Robotics Corporation, Summerour Robotics, Atlanta, Ga.

As described above, in an embodiment, the headset 88 provides full duplex audio directly to one of the cameras, such as the tracking camera 84. If the headset 88 is a typical wireless headset that is designed for connection directly to a phone, use of such a headset with a camera will require some modification of the connectors.

The full duplex audio jacks used on the Sony SNC RZ50N PC & Network Camera and other conventional security cameras are called mini phone jacks, or ⅛ inch (3.5 mm) phone jacks. They are similar to the phone jacks on conventional sound cards on computers. These jacks are designed to work with either stereo or monaural plugs, though Sony specifications state that their jacks are monaural.

There are a number of wireless headsets designed to work with these jacks, but they are either infrared (line of sight), Bluetooth (short distance) or suffer from other distance-related problems. The Plantronics CS50 Wireless Office Headset System provides 300 feet of transmitting distance, but is designed to plug in between a conventional telephone handset and the base of the telephone. As such, such headsets employ what is called an RJ10 (4P4C, four position, four contact) modular plug. This type of plug cannot plug into conventional security cameras. In accordance with an embodiment described with FIGS. 11 to 13 below, an alteration is made in the connection structure between the camera and a transmitter for the headset, allowing these two off-the-shelf components to be used together.

FIG. 11 shows the tracking camera 84 attached to a transmitter 300 for the wireless headset 88 in accordance with an embodiment. The transmitter 300 is connected to the camera by a cable 302. To connect the wireless headset 88 (which in this case is a wireless headset made for attachment to a phone), a modification is made in the cable that connects to the transmitter 300 and that normally connects to a phone. Specifically, the cable 302 is altered to include two ⅛ inch phone plugs (310, 312; FIG. 12) on one side and an RJ10 plug 304 on the other. One end of the cable (i.e., the RJ10 plug 304) is connected to the wireless headset transmitter, and the other end (i.e., the end having the two ⅛ inch phone plugs 310, 312) is plugged into the camera 84 (alternatively, the end that is plugged into the camera may be plugged into a sound card of a computer).

Details of the cable 302 are shown in FIG. 11. The cables that come with most conventional wireless headsets such as described above include first and second RJ10 plugs, represented by 304 and 306 in the drawings. In accordance with an embodiment, one of the plugs (306 in FIG. 12) is replaced by a circuit 308 and the two plugs 310, 312. As shown in FIG. 12, such plugs as the plug 306 include pins, in this case four, which carry left and right channels of full duplex sound. For one conversion, the pins are replaced as follows:

Pin 1 is electrically connected to the shield of the microphone plug 310.

Pin 2 is electrically connected the tip of speaker plug 312.

Pin 3 is electrically connected to the shield of the speaker plug 312.

Pin 4 is electrically connected to the tip of the microphone plug 310.

The above arrangement permits the data typically provided to the plug 206 to go to the appropriate stereo locations (left/right, input/output) for the plugs 310, 312. As can be understood, a cable for a conventional wireless headset may include a different arrangement than described here, but the particular arrangement described works to properly direct full duplex audio for the products described herein.

The circuit 308 is provided so that the impedance of the camera 84 matches the impedance of the headset 88. The circuit 308 shown utilizes a resister and a transformer as passive components to match the impedance of the camera 84 and the transmitter 300, but a person of ordinary skill may choose a different circuit.

As further described below, the tracking camera 84 and/or the robot camera 86 are configured so that they move to film the student S as the student moves around the arena. Specifically, the tracking camera 84 may pan, zoom, and/or tilt to follow movements, and the robot camera 86 may perform these same movements, and additionally may move via its platform to a desired location for filming. Movements of the tracking camera 84 and/or the robot camera 86 may be controlled remotely by a trainer via one of the training computers 40 so that a trainer may visually inspect the appropriate portion of the student's riding skills. If desired, a different type of tracking camera 84 or robot camera 86 may be used that automatically follows a sensor or transmitter that may be placed on the student or the student's horse. Cameras may be configured to track a horse's brush boots. In this manner, a trainer does not have to control movements of the cameras.

Although a single tracking camera 84, a robot camera 86, and a wide angle camera are shown, any of these may be omitted, and two or more of each of the cameras may be utilized for an arena 80. In addition, additional cameras and/or microphones may be used for an arena. In an embodiment, cameras may be positioned in the locations of judges for an event such as dressage. If desired, an arena may have microphones to allow stereo effects or surround sound.

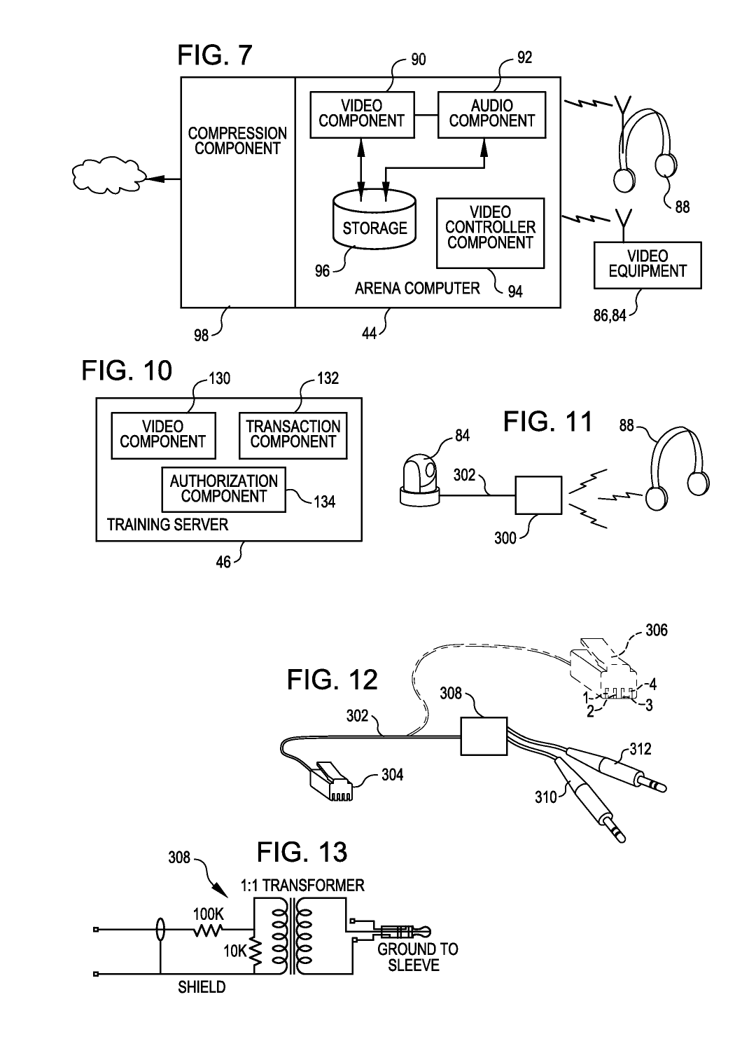

An arena computer 44 in accordance with embodiment is shown in FIG. 7. The arena computer includes a video component 90 and an audio component 92. In addition, the arena computer 44 shown in FIG. 7 includes a video controller component 94, storage 96, and a compression component 98.

The video component 90 accesses or receives the video obtained via the wide angle video camera 82, the tracking camera 84, and/or the robot camera 86. The audio component 92 obtains the audio feed, for example, from the headset 88 or any other external microphones that may be used with the system. As described earlier, this audio feed may be obtained through a camera or may be obtained separately and may be sent to the arena computer. Preferably, the video component 90 and the audio component 92 are matched in timing so that audio feed and video feed match one another as they are provided by the arena computer 44. Although the video component 90 and the audio component 92 are shown as separate entities, these components may be provided by a single entity, especially where the audio is recorded by a camera.

The video controller component 94 is utilized to operate the movements of the tracking camera 84 and/or the robot camera 86. Such software is known, and is provided for cameras such as the SNC-RZ50N security camera described above.

The storage 96 is provided for storing some or all of the video from the video component 90 and some or all of the audio from the audio component 92. The storage 96 is optional, and video and audio information taken in the arena 80 through the headset 88 and the cameras or video equipment 84, 86, and 82 need not be stored, and may be directly transmitted as received. In addition, as described below, video and audio may be stored in another location, such as the training server 46.

In an embodiment, the compression component 98 further compresses video and/or audio information received at the arena prior to transmission of that video and audio information. Such a compression component 98 may be provided on existing security video servers. An example of a computer that may be used for the arena computer 44 is a security and monitoring server such as the servers provided by SAM Systems, Inc. of Warren, Mich., for example, the PDX-M100-H250 Server. Such a server includes appropriate software to compress video and send it at a rate over the Internet to allow television quality real-time viewing, for example, 24 frames per second or greater.

An arena 80 wishing to participate in the system maintains at least some of the equipment shown in FIG. 6. As an example, the arena 80 utilizes the arena computer 44 and one or more of the cameras 82, 84, and 86. In addition, if the arena 80 offers training to the public through the system, the arena 80 registers with the training server 44 or otherwise becomes a part of the system. The arena 80 may become authenticated through the authorization component 134 of the training server 46. The arena 80 may be provided a user interface or another method for indicating available time of the arena. Payment information, such as rental charges, information about where the arena would like to receive checks, or information about a banking account into which money may be automatically deposited by the system, may be provided as an arena is registered.

A trainer that wishes to utilize the system registers with the system, for example via the authorization component 134. The trainer may be required to have a particular certification or to have particular credentials provided by an administrator of the system before being allowed to register. After registered, a trainer may log into the system via one of the training computers 40 and may provide available times for training. The trainer may also log in through any computer or device that has access to the training server 46, for example via the Internet.

As stated above, a student may utilize the availability information provided by a trainer to select the trainer for a training session. To attend a training session, a trainer downloads the necessary software, if not already present, into a training computer 40. This software permits the trainer to view remotely the video that is produced at the arena 80 and/or to control the cameras 84 and/or 86. A session identification or other information may be provided by the training server 46 to permit a trainer to enter the appropriate training session. In an embodiment shown in FIG. 9, the training computer utilizes a video analyzer 112, an audio component 114, and a video controller component 116.

The video analyzer 112 permits the trainer to view live video feed from the arena 80. The audio component 114 permits the trainer to receive and send audio from and to the student. To this end, an audio input/output device 118 may be provided, such as a headset with a microphone, a telephone headset, or other audio equipment that may connect to the computer and provide audio signal to and from the computer. The device 118 may be two components, such as a microphone and speakers.

The video controller component 116 permits a trainer to move the cameras 84 and/or 86 using a video controller 120. Such software is available with existing IP security cameras such as is described above. The video controller 120 may utilize keystrokes on a keyboard, or may be a joystick or other device for controlling movement of the cameras 84 and/or 86. An example of a joystick is a CH Products Internet Protocol Desktop Controller for USB. Other controllers may be used.

Utilizing the trainer computer 40, a trainer has two-way audio communication with the student S. In an embodiment, this two way audio communication is full duplex communication, although such communication is not required. In addition, the instructor has full viewing capability via the video analyzer 112 of real time video. By “real time,” we mean as the video is taking, less any minor latency in the system and network.

The instructor can control the functions and positioning of the cameras via the video controller component 116. In an embodiment, the instructor can archive portions of video, for example at the storage 96 at the arena computer, or locally on the trainer computer 40, as necessary. Alternatively, storage may be provided at the training server 46. Using the stored video, an instructor may review portions of video after the session or at the next session. In addition, as shown FIG. 8, an instructor may utilize a video analyzer page 100 to compare a prior video 101 of a student to a contemporary or more recent video 104. By viewing the two side by side, the instructor can determine improvement. For example, as shown in FIG. 8, the user's posture has improved, as well as the user's foot position. In an alternate embodiment, instead of side by side juxtaposition of two videos, the two may be superimposed one over the other. The analyzer may also allow people other than trainers, such as veterinarians, to analyze a horse's gait over time as a diagnostic tool.

The transaction component 132 of the training server 146 charges a student's account for a session, and then credits the appropriate arena and/or trainer. If desired, an arena and/or trainer may be charged a monthly or other periodic fee for having access to the system. Alternatively, the system may take a portion of the fee paid for each session. The transaction component 132 may credit the appropriate amount to an arena utilizing the information maintained by the authorization component 134. Similarly, the transaction component 132 may credit an appropriate trainer utilizing the account information maintained by the authorization component 134. A transaction may be completed upon a student scheduling an arena and trainer as described above, or may be completed by another event, such as a signal sent by an arena that a session has been completed, or a similar signal by a trainer. In either event, the payment information may be handled as appropriate by the transaction component 132.

Although described with reference to video being provided to a trainer, the video may additionally or alternatively be provided from the trainer to the student.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of remote training by a trainer of an activity performed by a student, comprising:
receiving and reviewing real time video of student actions over a network, the student being located at a location; and
based upon the real time video, providing instructions to the student.

2. The method of claim 1, wherein the instructions are provided via full duplex audio.

3. The method of claim 1, further comprising, controlling movement of at least one camera at the location via the network.

4. The method of claim 1, wherein controlling movement comprises utilizing a video controller to instruct said at least one camera.

5. The method of claim 1, wherein the video controller comprises a joystick.

6. The method of claim 1, wherein the activity comprises horseback riding.

7. The method of claim 6, wherein the location comprises an arena.

8. A method for receiving remote training from a trainer, comprising:
transmitting real time video of student actions over a network, the student being located at a location; and
receiving instructions based upon the real time video to the student.

9. The method of claim 8, wherein the instructions are received via full duplex audio.

10. The method of claim 9, wherein the student receives instructions via a wireless headset.

11. The method of claim 10, wherein the wireless headset is configured for connection to a conventional phone, and is connected directly to a camera that is configured to receive conventional mini phone jacks.

12. The method of claim 8, further comprising, providing to the trainer control of movement of at least one camera at the location via the network.

13. The method of claim 8, wherein the activity comprises horseback riding.

14. The method of claim 13, wherein the location comprises an arena.

15. A computerized method for remote training by a trainer of an activity performed by a student, comprising:
maintaining information about availability of a trainer; and
providing a first user interface through which a student may select a trainer.

16. The method of claim 15, further comprising maintaining information about availability of an arena at which a student may be trained; and
providing a second user interface through which a student may select an arena.

17. The method of claim 16, wherein the first user interface and the second user interface comprise a single, shared user interface.

18. The method of claim 16, further comprising, as a result of selecting a selected arena by a student, debiting an account of the student and crediting an amount to the selected arena.

19. The method of claim 18, further comprising, as a result of selecting a selected trainer by a student, crediting an amount to the selected arena.

20. The method of claim 18, further comprising, as a result of selecting a selected trainer by a student, crediting an amount to the selected arena.

21. The method of claim 15, wherein the activity comprises horseback riding.
